(19) United States
(12) Patent Application Publication
(10) Pub. No.: US 2025/0251262 A1
(43) Pub. Date: Aug. 7, 2025

(54) TOOL MATCHING USING DIGITAL TWINS

(71) Applicant: FEI Company, Hillsboro, OR (US)

(72) Inventors: Egbert Algra, Eindhoven (NL); Remco Schoenmakers, Eindhoven (NL); Alexandre Dufour, Bordeaux (FR)

(21) Appl. No.: 18/435,486

(22) Filed: Feb. 7, 2024

(51) Int. Cl. G01D 18/00; G01D 11/00

(52) U.S. Cl. CPC G01D 18/00; G01D 11/00

(57) ABSTRACT

In some embodiments, a tool-matching system includes a first controller and a plurality of second controllers. Each of the second controllers is configured to support a digital twin and control configuration parameters of the corresponding measuring instrument. The first controller is configured to estimate configuration-parameter changes for the measuring instruments based on instrument drift data. The estimated parameter changes are directed at tool matching the measuring instruments at a future time. The first controller is also configured to receive a plurality of reports evaluating the estimated configuration-parameter changes. Each of the reports is generated with the respective digital twin based on a respective subset of the estimated configuration-parameter changes. The first controller is also configured to instruct the second controllers to implement the estimated configuration-parameter changes when the reports indicate effectiveness of the estimated configuration-parameter changes for the tool matching of the measuring instruments at the future time.

### TECHNICAL FIELD

Various examples relate generally to metrology and, more specifically but not exclusively, to methods and apparatus for reducing disparities between measuring instruments.

### SUMMARY

Applied, technical, or industrial metrology is concerned with the application of measurement to manufacturing or other industrial processes to ensure the suitability of measuring instruments, the calibration of such instruments, and quality control for the intended purpose. For example, obtaining good measurements is important in many industries because measurements tend to have a significant impact on the value and quality of the end product, as well as on the production costs. In some cases, traceability and correctability of the instrument performance between calibrations is an important capability to have for providing high confidence in the measurement results and good consistency among a plurality of measuring instruments.

Disclosed herein are, among other things, various examples, aspects, features, and embodiments of a tool-matching system having a master controller communicating with electronic controllers of individual measuring instruments of a fleet of such instruments to determine and perform configuration-parameter changes directed at maintaining the fleet in an acceptable tool-matching state between fleetwide calibrations. In some examples, the master controller estimates fleetwide configuration-parameter changes based on instrument drift data received from the electronic controllers, verifies effectiveness of the estimated fleetwide configuration-parameter changes for tool matching via digital-twin simulations, and pushes appropriate subsets of the verified fleetwide configuration-parameter changes to individual measuring instruments of the fleet. In at least some use cases, the implemented fleetwide configuration-parameter changes beneficially reduce the frequency of fleetwide calibrations and associated production-line disruptions.

One example provides an automated tool-matching method for a plurality of measuring instruments, the method comprising: with a first controller, estimating configuration-parameter changes for the plurality of measuring instruments based on instrument drift data received from a plurality of second controllers, the estimated parameter changes being directed at tool matching the plurality of measuring instruments at a future time, each of the second controllers being configured to support a respective digital twin of a corresponding one of the measuring instruments and further configured to control configuration parameters of the corresponding one of the measuring instruments; with the first controller, receiving from the plurality of second controllers a plurality of reports evaluating the estimated configuration-parameter changes, each of the reports being generated with the respective digital twin based on a respective subset of the estimated configuration-parameter changes for the plurality of measuring instruments; and with the first controller, instructing the plurality of second controllers to implement the estimated configuration-parameter changes when the plurality of reports indicates effectiveness of the estimated configuration-parameter changes for the tool matching of the plurality of measuring instruments at the future time.

Another example provides a tool-matching system comprising: a first controller; and a plurality of second controllers, each of the second controllers being configured to support a respective digital twin of a corresponding one of a plurality of measuring instruments and further configured to control configuration parameters of the corresponding one of the measuring instruments, wherein the first controller is configured to: estimate configuration-parameter changes for the plurality of measuring instruments based on instrument drift data received from the plurality of second controllers, the estimated parameter changes being directed at tool matching the plurality of measuring instruments at a future time; receive from the plurality of second controllers a plurality of reports evaluating the estimated configuration-parameter changes, each of the reports having been generated with the respective digital twin based on a respective subset of the estimated configuration-parameter changes for the plurality of measuring instruments; and instruct the plurality of second controllers to implement the estimated configuration-parameter changes when the plurality of reports indicates effectiveness of the estimated configuration-parameter changes for the tool matching of the plurality of measuring instruments at the future time.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, in which:

FIG. 1 is a block diagram illustrating a processing pipeline of a digital twin according to some examples.

FIG. 2 is a block diagram illustrating an instrument control system that can be used for tool matching according to some examples.

FIG. 3 is a flowchart illustrating a tool-matching method implemented at the master controller of the instrument control system of FIG. 2 according to some examples.

FIG. 4 is a flowchart illustrating a tool-matching method implemented at an individual instrument controller of the instrument control system of FIG. 2 according to some examples.

FIG. 5 is a block diagram illustrating a computing device according to some examples.

### DETAILED DESCRIPTION

As semiconductor-device patterns are scaled down in semiconductor manufacturing processes, control of critical dimensions of such patterns is becoming a priority for many semiconductor fabrication plants (often referred to as fabs). For example, the transistor-gate critical dimension (CD) is typically on the order of several nanometers. Each nanometer deviation from the targeted gate length may affect the operational speed of the device. In addition, when the post-etch gate CD is too small, the threshold voltage shift and leakage current can render the corresponding semiconductor device inoperative. In an automated foundry environment, the target gate CD can be achieved in several different ways. For example, using in-line process monitoring, the lithography and etch tools can be tuned to improve the CD performance of the fab and reduce the final wafer-to-wafer CD variation.

An important component of in-line process monitoring includes the use of dimension measuring instruments. Technical requirements to such instruments include high measurement accuracy and good consistency in performance. Example challenges related to the measurements performed with such instruments include, but are not limited to, increasing the measurement accuracy of individual measuring instruments, reducing disparities in dimension measurements between different individual instruments in a plurality of measuring instruments deployed in the production line, and reducing variations in dimension measurements obtained by an individual measuring instrument over time.

For example, electron microscopes, such as scanning electron microscopes (SEMs) and/or transmission electron microscopes (TEMs), can be used in semiconductor fabrication plants to measure various dimensions, including CDs, of semiconductor devices. A typical electron microscope is a sophisticated and technically complex instrument characterized by a relatively large number of configuration parameters. In operation, the electron microscope can be calibrated to establish a relationship between the configuration-parameter values and certain specific physical measures. Several different calibration types may be involved in a process of placing the microscope into a proper working configuration.

One example calibration procedure is magnification calibration. More specifically, the projector system lenses of an electron microscope have specific currents, resulting in certain enlargement of the specimen image in the plane of the camera sensor. The magnification calibration relates the lens currents to the pixel size in the captured image. For example, a lens current of 200 mA may correspond to the image scale of 100 nm per pixel. Additional nonlimiting examples of calibration procedures include image shift calibration, stage shift calibration, and focus calibration. The image shift calibration relates deflector-coil currents to a change in the beam position on the sample plane. The stage shift calibration relates a magnitude of the stimulus applied to the motor drive of the microscope stage to a change in the position of the sample. The focus calibration relates the objective lens currents to the position of the focal point along the longitudinal axis of the electron beam (often referred to as defocus).

After a microscope is calibrated, the microscope typically begins to exhibit a drift in performance, which causes deviations from the expected performance. As used herein, the term “deviation” refers to a difference between a set point of the calibration and the actually exhibited state or behavior of the instrument. As an example, suppose that at the time of the focus calibration the exhibited behavior is such that, with the objective lens current of I₀ mA, the electron beam defocus is 1 nm. However, later in time, at the same objective lens current, the electron beam defocus becomes 10 nm. The 9-nm difference (=10-1) is referred to as the deviation from the corresponding setpoint of the focus calibration. Gradual change of the set point over time is referred to as “drift.” Some additional examples of microscope drifts include, but are not limited to, magnification drift, image shift drift, stage shift drift, Eucentric height drift, and gun tilt drift. As used herein, the term “drift data” refers to a digital form of processed or unprocessed sensor signals and/or detector signals based on which deviations from the expected performance can be ascertained and/or quantified. In some examples, such sensor and/or detector signals are generated with one or more of a direct-electron detection camera, a CCD camera, a high-speed digital camera, a video camera optically coupled to a fluorescent screen (such as a commercially available FluCam device), and a scanning transmission electron microscope (STEM) detector.

In some examples, an electron microscope is provided with a digital twin. As used herein, the term “digital twin” refers to a virtual model of the corresponding instrument. Such a model typically spans the instrument's lifecycle and uses data received from various sensors and/or detectors associated with the instrument to simulate the instrument's behavior, monitor operations, and/or recommend configuration adjustments. The digital twin can be used, for example, to view the status of the instrument on demand. When sensors collect data from the instrument, the sensor data can be used to update the digital twin in real time. In various examples, the digital twin can provide an up-to-date and accurate representation of the instrument's properties and states, including the above-mentioned drifts. As used herein, the term “real time” refers to a computer-based process that controls a corresponding environment by receiving data, processing the received data, and generating a response sufficiently quickly to affect the environment without significant delay. Real-time responses are often understood to be on the order of milliseconds, or sometimes microseconds. In the context of a digital twin, “real-time” updates mean that the digital twin sufficiently accurately represents the corresponding actual instrument at any point in time.

For illustration purposes and without any implied limitations, example embodiments are described below in reference to electron microscopes. However, various embodiments are not so limited. As used herein, the term “measuring instrument” should be interpreted to encompass at least the following types of instruments: electron microscopes, focused ion beam (FIB) instruments, and dual beam (e.g., FIB/SEM) instruments. Based on the provided description, a person of ordinary skill in the pertinent art will be able to make and use various embodiments corresponding to various types of measuring instruments without any undue experimentation.

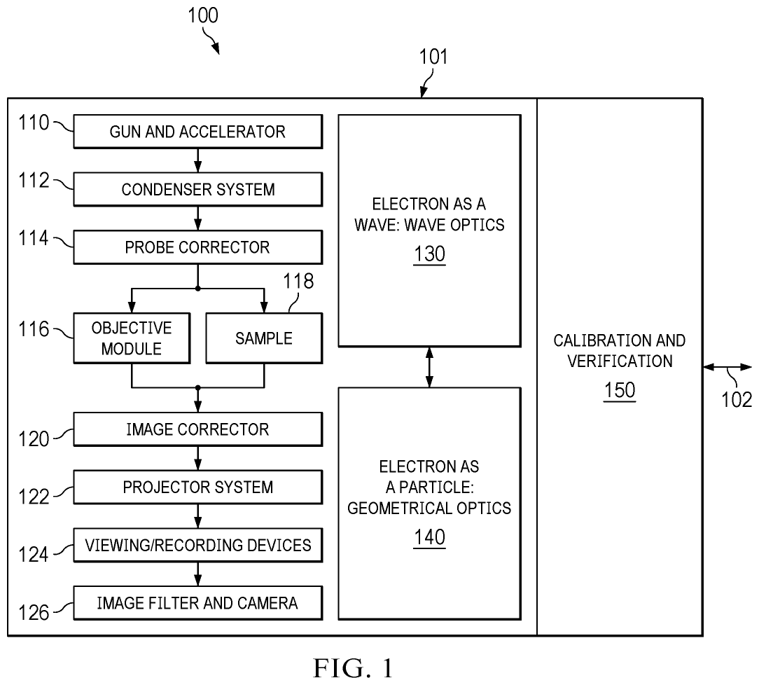

FIG. 1 is a block diagram illustrating a processing pipeline 101 of a digital twin 100 according to some examples. In the example shown, the digital twin 100 represents a TEM instrument (not explicitly shown in FIG. 1) with which the digital twin 100 communicates via an interface 102. The processing pipeline 101 includes a plurality of model modules 110-126 corresponding to different respective physical components of the TEM instrument. As an illustration, the following model modules are shown: the electron gun and accelerator model module 110; the condenser lens model module 112; the probe corrector model module 114; the objective lens model module 116; the sample model module 118; the image corrector model module 120; the projector lens system model module 122; the viewing and recording devices model module 124; and the image filter and camera model module 126. In other examples, a different (from the shown) set of model modules can also be used to implement the processing pipeline 101.

Different ones of the model modules 110-126 may communicate with one another, e.g., as indicated in FIG. 1. For example, an output of one model module of the processing pipeline 101 may serve as an input to another model module of the processing pipeline 101. In some examples, a concatenation of the model modules 110-126 is configured to provide simulations of how various settings of the electron microscope column are related to the signals detected with the pertinent sensor or detector. In some examples, an input to a model module includes a wave function or a ray diagram, and a corresponding output of that model module includes a modified wave function or ray diagram, with the modification being obtained using a computational model of how the parameter settings of the corresponding component of the electron microscope column module (such as the lens currents, etc.) affect the pertinent electron-beam characteristics. A wave optics model module 130 and a geometrical optics model module 140 are configured to appropriately communicate with the individual ones of the model modules 110-126 to support electron-beam propagation simulations encompassing the optical path(s) between the electron source (represented by the electron gun and accelerator model module 110) and the electron sink (represented by the image filter and camera model module 126) of the TEM instrument. The use of both modules 130, 140 for such simulations enables the digital twin 100 to properly account for the effects of wave-particle duality exhibited by electrons in at least some components and/or configurations of the TEM instrument.

In operation, the model modules 110-126 are subjected to periodic or continuous parameter updates performed using a calibration and verification module 150. In various examples, such parameter updates are based on a comparison of actual measurement results received by the calibration and verification module 150 from the TEM instrument with the corresponding model simulations performed using the model modules 110-126, 130, 140. For example, when the comparison reveals a sufficiently large discrepancy, one or more parameters used in the model modules 110-126 are updated to have various drifts occurring in the TEM instrument properly reflected in the digital twin 100.

Different TEM or SEM instruments deployed at the production facility may be calibrated at different times. The drift rates exhibited by different instruments may also vary. For these reasons, maintaining good and sufficient consistency among the instruments of a relatively large fleet of instruments may be challenging. The corresponding problem is sometimes referred to as “tool matching.”

In one approach, tool matching is achieved by calibrating the whole fleet of instruments regularly and frequently. However, after a calibration, the instruments start to drift in performance in different ways. The drifts cause the above-mentioned deviations, which are not corrected under this approach until the next time the whole fleet is calibrated and made consistent again. In at least some use cases, this approach may be rather disruptive and/or time-consuming. Example embodiments disclosed herein address this problem by monitoring a plurality of instruments and predicting expected deviations using the respective digital twins of the instruments (such as the digital twin 100). In some examples, the digital twins are beneficially used to determine what changes in the respective instrument control parameters are needed for each instrument to maintain across-the-fleet consistency in performance without compromising the accuracy of measurements. The determined changes are then pushed to the physical instruments to beneficially reduce the frequency of calibrations and associated production-line disruptions.

In general, it can be said that tool matching is achieved when different instruments of the fleet of instruments produce the “same” (within specified error bounds) measurement result for the same experiment. The measurement/experiment type may vary depending on the use case. For example, when the intensity of images needs to be matched, the corresponding experiment is specifically configured to accurately measure the intensity values while some other characteristics (such as magnification, for example) may not be factored in as stringently. Similarly, when the feature sizes need to be matched, the corresponding experiment is specifically configured to accurately measure the effective magnification while the image intensity may not be a significant factor in that experiment.

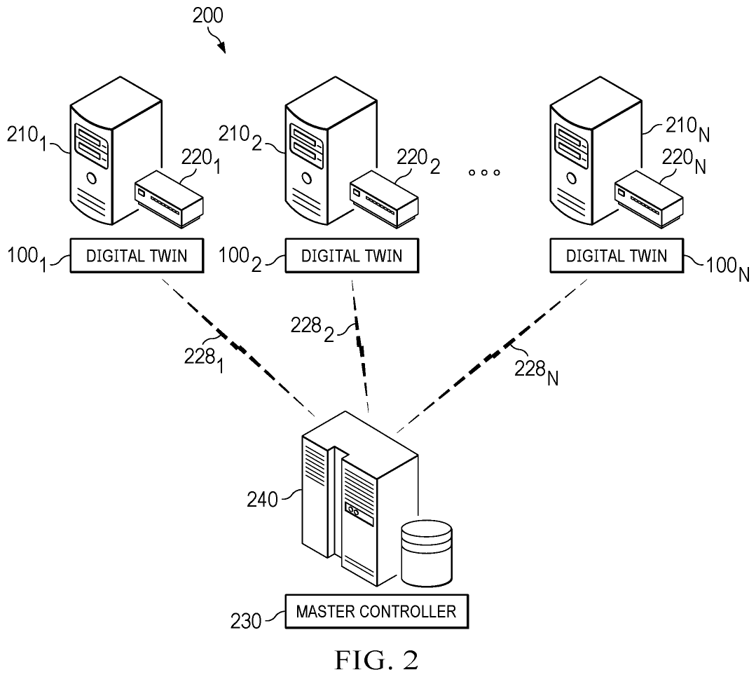

FIG. 2 is a block diagram illustrating an instrument control system 200 that can be used for tool matching according to some examples. The system 200 includes N measuring instruments 210₁-210_{N}, where N is a positive integer greater than one. In some examples, the number N is in the range between five and fifty. In some examples, each of the measuring instruments 210₁-210_{N} is or includes an electron microscope.

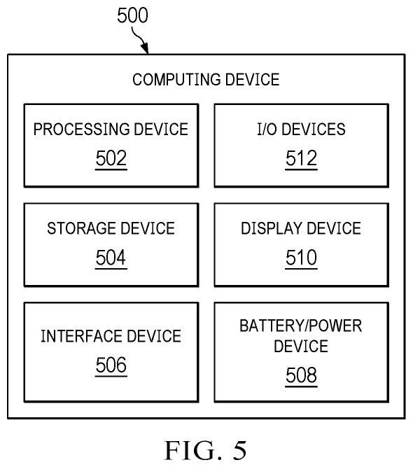

Each measuring instrument 210ₙ is connected to a respective electronic controller 220ₙ, where n=1, 2, . . . , N. The electronic controller 220ₙ has operative control over configuration parameters of the measuring instrument 210ₙ and includes a respective computing device (not explicitly shown in FIG. 2, see FIG. 5) configured to support a respective digital twin 100ₙ (also see FIG. 1). Each of the electronic controllers 220₁-220_{N} has a respective communication link 228ₙ to a master controller 230. In the example shown, the master controller 230 is implemented using a suitable computing device (e.g., a network-connected server) 240. In operation, the electronic controllers 220₁-220_{N} and the master controller 230 exchange control messages over the corresponding communication links 228ₙ that enable the system 200 to perform tool matching for the measuring instruments 220₁-220_{N}, e.g., as described in more detail below.

For illustration purposes and without any implied limitations, let us consider an example in which N=3 and the corresponding measuring instruments 210₁-210₃ are electron microscopes configured to perform metrology measurements on transistor dimensions. Suppose we have a transistor with a CD of 3.2 nm. For tool matching purposes, we want each of the electron microscopes 210₁-210₃ to produce the same CD value of 3.2 nm within a specified tolerance of 0.05 nm (i.e., within 3.2±0.05 nm) by performing automated measurements on that transistor. This outcome can be achieved, for example, by properly aligning and calibrating the electron microscopes 210₁-210₃ on a test sample having confirmed dimensions. The calibration will produce three respective sets of configuration parameters for the electron microscopes 210₁-210₃.

The digital twins 100₁-100₃ receive the three respective sets of configuration parameters with an indication that an acceptable tool-matching state has been achieved at the calibration time with these parameters. In operation following the calibration, each of the electron microscopes 210₁-210₃ continuously sends acquired images and related sensor information to the corresponding electronic controller 220ₙ. Each electronic controllers 220ₙ uses the received data and the corresponding model modules of the data twin 100. (also see FIG. 1) to extract drift data. The drift data are communicated by the electronic controllers 220₁-220₃ to the master controller 230 via communication links 228₁-228₃. The master controller 230 models the effects of those drifts, as applied to the specific use case, to extrapolate and determine the effect of the drifts on the tool-matching state of the whole fleet of electron microscopes at a future time. When the master controller 230 determines that one or more of the predicted deviations exceed the tool-matching tolerance specified for this particular use case, the master controller 230 operates to determine corrections to the respective sets of configuration parameters for the electron microscopes 210₁-210₃ that will keep the whole fleet within the specified tool-matching tolerance. The determined parameter corrections are then pushed, via the electronic controllers 220₁-220₃, onto the electron microscopes 210₁-210₃ to maintain a desired state of tool matching across the fleet without having to perform another calibration on the test sample at that time.

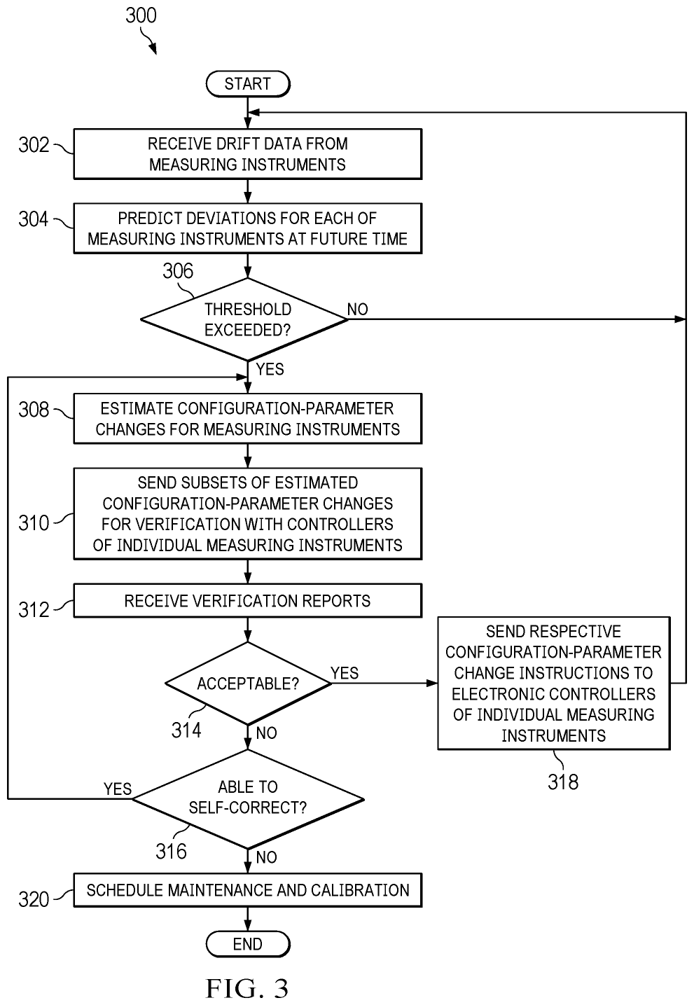

FIG. 3 is a flowchart illustrating a tool-matching method 300 implemented at the master controller 230 of the instrument control system 200 according to some examples. The method 300 includes the master controller 230 receiving drift data corresponding to the measuring instruments 210₁-210_{N} (in a block 302). For each measuring instrument 210ₙ, the drift data are extracted by the corresponding electronic controller 220ₙ from the detector and sensor data received from the instrument, are processed using the corresponding digital twin 100ₙ, and are sent to the master controller 230 via the communication link 228ₙ as indicated above.

The method 300 also includes the master controller 230 predicting deviations for each of the measuring instruments 210₁-210_{N} at a future time (in a block 304). In some examples, the predictions are made (in the block 304) by appropriately extrapolating the drift data received in the block 302. The time increment for selecting the future time for the block 304 is an algorithm parameter that depends on the use case. In various examples, the time increment can be in the range between several minutes and several hours.

The method 300 also includes the master controller 230 determining whether the predicted deviations for any of the measuring instruments 210₁-210_{N} exceed a predetermined threshold value (in a decision block 306). The predetermined threshold value is an algorithm parameter that depends on the use case and is related to the above-mentioned tolerance to the measurement variations between different instruments 210ₙ of the whole fleet of instruments. When the predicted deviations are smaller than the threshold value (“No” at the decision block 306), the processing of the method 300 is directed back to the operations of the block 302. When the predicted deviations exceed the threshold value (“Yes” at the decision block 306), the processing of the method 300 is directed to a block 308.

Operations of the block 308 include the master controller 230 determining estimated configuration-parameter changes for one or more of the measuring instruments 210₁-210_{N}. This determination is directed at finding a fleetwide set of configuration-parameter changes that place the measuring instruments 210₁-210_{N} into respective configurations that together satisfy the tool-matching specifications for the fleet. In some examples, the configuration-parameter changes are determined in the block 308 using a neural network implementing a fleetwide model that maps a vector having deviations as components thereof onto a corresponding vector of parameter changes that are expected to correct the deviations to such an extent as to keep the entire fleet of measuring instruments 210₁ within the tool-matching specifications at the future time. The neural network can be trained using machine-learning methods with previous drift and calibration data acquired for the entire fleet of measuring instruments 210ₙ and with a suitably constructed loss function adapted to the use case. When the trained neural network is presented with a deviation vector constructed using the deviations predicted in the block 304, the neural network outputs a corresponding estimated vector of parameter changes for the measuring instruments 210₁-210_{N}. In some other examples, other suitable fleetwide models can also be used to estimate configuration-parameter changes.

The method 300 also includes the master controller 230 sending the estimated configuration-parameter changes for verification to the electronic controllers 220₁-220_{N} (in a block 310). In some examples, operations of the block 310 include: (i) parsing the estimated vector of configuration-parameter changes determined in the block 308 into subsets of configuration-parameter changes corresponding to different individual measuring instruments 210ₙ and (ii) sending the subsets to the respective electronic controllers 220ₙ via the communication links 228g. Upon receiving the respective subset of configuration-parameter changes from the master controller 230, each electronic controller 220ₙ operates to determine the effects of such changes on the measurements performed with the corresponding individual measuring instrument 210ₙ by running the configuration-parameter changes through the corresponding digital twin 100ₙ. The electronic controller 220ₙ then reports the determined effects back to the master controller 230. The method 300 further includes the master controller 230 receiving respective evaluation reports from the electronic controllers 220₁-220_{N} (in a block 312).

The method 300 also includes the master controller 230 determining whether the estimated parameter changes are acceptable (in a decision block 314). This determination is made in the decision block 314 based on the evaluation reports received from the electronic controllers 220₁-220_{N} in the block 312. In some examples, the estimated parameter changes are deemed unacceptable when at least one of the evaluation reports indicates that the corresponding measuring instrument 210ₙ will not meet the tool-matching specifications if the respective subset of configuration-parameter changes is implemented thereat. When the estimated configuration-parameter changes are deemed unacceptable (“No” at the decision block 314), the processing of the method 300 is directed to a decision block 316. When the estimated configuration-parameter changes are deemed acceptable (“Yes” at the decision block 314), the processing of the method 300 is directed to a block 318.

Operations of the block 316 include the master controller 230 determining whether the fleet of instruments 210 can still attain an acceptable tool-matching state at the future time. In various examples, this determination can be made based on the number of iterations through the block 308 and/or the magnitude of deviations indicated in the evaluation reports of the block 312. For example, in some cases, when the number of iterations through the block 308 reaches a fixed predetermined number, the master controller 230 will determine that the instrument fleet is unbale to self-maintain an acceptable tool-matching state without a fleetwide service and/or calibration. In some other cases, when the magnitude of deviations indicated in the verification reports for two or more instruments exceed a fixed threshold value, the master controller 230 will determine that the instrument fleet is unbale to self-maintain an acceptable tool-matching state without a fleetwide service and/or calibration. When the master controller 230 determines that that the instrument fleet is able to self-maintain an acceptable tool-matching state without a fleetwide service or calibration (“Yes” at the decision block 316), the processing of the method 300 is directed back to the block 308, where another attempt to find an acceptable vector of parameter changes is made, e.g., using an updated input vector appropriately constructed using the evaluation reports of the block 312. When the master controller 230 determines that that the instrument fleet is unable to self-maintain an acceptable tool-matching state without a fleetwide service or calibration (“No” at the decision block 316), the processing of the method 300 is directed to a block 320.

Operations of the block 318 include the master controller 230 sending configuration-change instructions to the electronic controllers 220₁-220_{N}. The configuration-change instructions are based on the vector of parameter changes estimated by the master controller 230 in the last instance of the block 308 and then verified with the electronic controllers 220₁-220_{N} via the blocks 310, 312. After the configuration-change instructions are sent to the electronic controllers 220₁-220_{N}, the processing of the method 300 is looped back to the block 302.

Operations of the block 320 include the master controller 230 flagging the fleet of instruments 210ₙ as being unable to self-correct, identifying a time after which the system 100 will no longer be in an acceptable tool-matching state, and scheduling a maintenance service and/or fleetwide calibration accordingly. After the operations of the block 320 are completed, the method 300 is terminated.

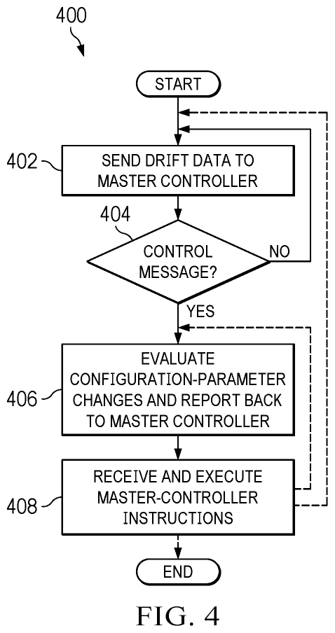

FIG. 4 is a flowchart illustrating a tool-matching method 400 implemented at an individual electronic controller 220ₙ of the instrument control system 200 according to some examples. The method 400 is compatible with the method 300 and is supported by communications between the electronic controller 220ₙ and the master controller 230, with the latter running the method 300.

The method 400 includes the electronic controller 220ₙ sending drift data corresponding to the measuring instrument 210ₙ to the master controller 230 (in a block 402). In various examples, the drift data are extracted by the electronic controller 220ₙ from the detector and sensor data received from the instrument 210ₙ using the digital twin 100ₙ as indicated above.

The method 400 also includes the electronic controller 220ₙ being in a standby mode for a control message from the master controller 230 (in a decision block 404). The expected control message is configured to provide the estimated configuration-parameter changes for the measuring instrument 210ₙ and is generated by the master controller 230 using the blocks 308, 310 of the method 300. If the control message is not received (“No” at the decision block 404), then the electronic controller 220ₙ remains in the standby mode, with the processing of the method 400 being looped through the block 402. When the control message is received (“Yes” at the decision block 404), the processing of the method 400 is directed to a block 406.

Operations of the block 406 include the electronic controller 220ₙ evaluating the estimated configuration-parameter changes communicated via the control message received from the master controller 230 in the block 404. In some examples, the evaluation is performed by inputting the received configuration-parameter changes into the digital twin 100ₙ and running pertinent simulations with the pertinent model modules thereof to determine deviations corresponding to the received parameter changes. Operations of the block 406 also include the electronic controller 220ₙ reporting the computed deviations back to the master controller 230. The reported deviations are received by the master controller 230 in the block 312.

The method 400 also includes the electronic controller 220ₙ receiving and executing instructions from the master controller 230 (in a block 408). Depending on the type of the received instructions, the processing of the method 400 may be looped back to the block 402 or 406 or may be terminated, after the received instructions are executed. For example, when a received instruction is to change the configuration parameters in response to the control message transmitted by the master controller 230 in the block 318 of the method 300, the processing of the method 400 is looped back to the block 402 after the received instruction is executed. When a received instruction is a next installment of the estimated configuration-parameter changes transmitted by the master controller 230 in a next instance of the block 310 of the method 300, the processing of the method 400 is looped back to the block 406. When a received instruction is a maintenance service notification transmitted by the master controller 230 in the block 320 of the method 300, the processing of the method 400 is terminated.

FIG. 5 is a block diagram illustrating a computing device 500 according to some examples. In various examples, the master controller 230 or an electronic controller 220ₙ may be implemented by a single computing device 500 or by multiple computing devices 500. In some examples, an instance of the computing device 500 can be configured to implement the method 300 or the method 400.

The computing device 500 of FIG. 5 is illustrated as having a number of components, but any one or more of these components may be omitted or duplicated, as suitable for the application and setting. In some embodiments, some or all of the components included in the computing device 500 may be attached to one or more motherboards and enclosed in a housing. In some embodiments, some of those components may be fabricated onto a single system-on-a-chip (SoC) (e.g., the SoC may include one or more electronic processing devices 502 and one or more storage devices 504). Additionally, in various embodiments, the computing device 500 may not include one or more of the components illustrated in FIG. 5, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 500 may not include a display device 510, but may include display device interface circuitry (e.g., a connector and driver circuitry) to which an external display device 510 may be coupled.

The computing device 500 includes a processing device 502 (e.g., one or more processing devices). As used herein, the terms “electronic processor device” and “processing device” interchangeably refer to any device or portion of a device that processes electronic data from registers and/or memory to transform that electronic data into other electronic data that may be stored in registers and/or memory. In various embodiments, the processing device 502 may include one or more digital signal processors (DSPs), application-specific integrated circuits (ASICs), central processing units (CPUs), graphics processing units (GPUs), server processors, or any other suitable processing devices.

The computing device 500 also includes a storage device 504 (e.g., one or more storage devices). In various embodiments, the storage device 504 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 504 may include memory that shares a die with the processing device 502. In such an embodiment, the memory may be used as cache memory and include embedded dynamic random-access memory (eDRAM) or spin transfer torque magnetic random-access memory (STT-MRAM), for example. In some embodiments, the storage device 504 may include non-transitory computer readable media having instructions thereon that, when executed by one or more processing devices (e.g., the processing device 502), cause the computing device 500 to perform any appropriate ones of the methods disclosed herein below or portions of such methods.

The computing device 500 further includes an interface device 506 (e.g., one or more interface devices 506). In various embodiments, the interface device 506 may include one or more communication chips, connectors, and/or other hardware and software to govern communications between the computing device 500 and other computing devices. For example, the interface device 506 may include circuitry for managing wireless communications for the transfer of data to and from the computing device 500. The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 506 for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device 506 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 506 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 506 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 506 may include one or more antennas (e.g., one or more antenna arrays) configured to receive and/or transmit wireless signals.

In some embodiments, the interface device 506 may include circuitry for managing wired communications, such as electrical, optical, or any other suitable communication protocols. For example, the interface device 506 may include circuitry to support communications in accordance with Ethernet technologies. In some embodiments, the interface device 506 may support both wireless and wired communication, and/or may support multiple wired communication protocols and/or multiple wireless communication protocols. For example, a first set of circuitry of the interface device 506 may be dedicated to shorter-range wireless communications such as Wi-Fi or Bluetooth, and a second set of circuitry of the interface device 506 may be dedicated to longer-range wireless communications such as global positioning system (GPS), EDGE, GPRS, CDMA, WiMAX, LTE, EV-DO, or others. In some other embodiments, a first set of circuitry of the interface device 506 may be dedicated to wireless communications, and a second set of circuitry of the interface device 506 may be dedicated to wired communications.

The computing device 500 also includes battery/power circuitry 508. In various embodiments, the battery/power circuitry 508 may include one or more energy storage devices (e.g., batteries or capacitors) and/or circuitry for coupling components of the computing device 500 to an energy source separate from the computing device 500 (e.g., to AC line power).

The computing device 500 also includes a display device 510 (e.g., one or multiple individual display devices). In various embodiments, the display device 510 may include any visual indicators, such as a heads-up display, a computer monitor, a projector, a touchscreen display, a liquid crystal display (LCD), a light-emitting diode display, or a flat panel display.

The computing device 500 also includes additional input/output (I/O) devices 512. In various embodiments, the I/O devices 512 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment of the system 100, various components of the interface devices 506 and/or I/O devices 512 can be configured to send and receive suitable control messages, suitable control/telemetry signals, and streams of data. In some examples, the interface devices 506 and/or I/O devices 512 include one or more analog-to-digital converters (ADCs) for transforming received analog signals into a digital form suitable for operations performed by the processing device 502 and/or the storage device 504. In some additional examples, the interface devices 506 and/or I/O devices 512 include one or more digital-to-analog converters (DACs) for transforming digital signals provided by the processing device 502 and/or the storage device 504 into an analog form suitable for being communicated to the corresponding components of the system 100.

According to one example disclosed above, e.g., in the summary section and/or in reference to any one or any combination of some or all of FIGS. 1-5, provided is an automated tool-matching method for a plurality of measuring instruments, the method comprising: with a first controller, estimating configuration-parameter changes for the plurality of measuring instruments based on instrument drift data received from a plurality of second controllers, the estimated parameter changes being directed at tool matching the plurality of measuring instruments at a future time, each of the second controllers being configured to support a respective digital twin of a corresponding one of the measuring instruments and further configured to control configuration parameters of the corresponding one of the measuring instruments; with the first controller, receiving from the plurality of second controllers a plurality of reports evaluating the estimated configuration-parameter changes, each of the reports being generated with the respective digital twin based on a respective subset of the estimated configuration-parameter changes for the plurality of measuring instruments; and with the first controller, instructing the plurality of second controllers to implement the estimated configuration-parameter changes when the plurality of reports indicates effectiveness of the estimated configuration-parameter changes for the tool matching of the plurality of measuring instruments at the future time.

In some examples of the above method, the estimating comprises: predicting respective deviations for the plurality of measuring instruments at the future time based on the instrument drift data; comparing the respective deviations with a threshold value; and when at least one of the respective deviations exceeds the threshold value, determining the estimated configuration-parameter changes that are predicted to produce an acceptable tool-matching state for the plurality of measuring instruments at the future time.

In some examples of any of the above methods, the determining is performed using a neural network trained with previous drift and calibration data corresponding to the plurality of measuring instruments.

In some examples of any of the above methods, the method further comprises: when the plurality of reports indicates ineffectiveness of the estimated configuration-parameter changes for the tool matching of the plurality of measuring instruments at the future time, deciding, with the first controller, whether the plurality of measuring instruments is placeable into an acceptable tool-matching state at the future time without a maintenance service or fleetwide calibration.

In some examples of any of the above methods, the method further comprises: when the deciding produces a determination that the plurality of measuring instruments is not placeable into the acceptable tool-matching state without the maintenance service or fleetwide calibration, flagging the plurality of measuring instruments for the maintenance service or for the fleetwide calibration.

In some examples of any of the above methods, the method further comprises: when the deciding produces a determination that the plurality of measuring instruments is placeable into the acceptable tool-matching state without the maintenance service or fleetwide calibration, performing a next iteration of the estimating further based on the plurality of reports.

In some examples of any of the above methods, each of the measuring instruments is an electron microscope instrument or a focused ion beam instrument.

In some examples of any of the above methods, the respective digital twin includes a plurality of model modules representing different respective physical components of the electron microscope instrument or the focused ion beam instrument, the model modules being subjected to recurrent parameter updates based on comparison of measurement results and corresponding model simulations.

In some examples of any of the above methods, the plurality of measuring instruments includes five or more measuring instruments.

Another example provides a non-transitory computer-readable medium storing instructions that, when executed by a computing device, cause the computing device to perform operations comprising any of the above methods.

According to yet another example disclosed above, e.g., in the summary section and/or in reference to any one or any combination of some or all of FIGS. 1-5, provided is a tool-matching system comprising: a first controller; and a plurality of second controllers, each of the second controllers being configured to support a respective digital twin of a corresponding one of a plurality of measuring instruments and further configured to control configuration parameters of the corresponding one of the measuring instruments, wherein the first controller is configured to: estimate configuration-parameter changes for the plurality of measuring instruments based on instrument drift data received from the plurality of second controllers, the estimated parameter changes being directed at tool matching the plurality of measuring instruments at a future time; receive from the plurality of second controllers a plurality of reports evaluating the estimated configuration-parameter changes, each of the reports having been generated with the respective digital twin based on a respective subset of the estimated configuration-parameter changes for the plurality of measuring instruments; and instruct the plurality of second controllers to implement the estimated configuration-parameter changes when the plurality of reports indicates effectiveness of the estimated configuration-parameter changes for the tool matching of the plurality of measuring instruments at the future time.

In some examples of the above system, to estimate the configuration-parameter changes, the first controller is configured to: predict respective deviations for the plurality of measuring instruments at the future time based on the instrument drift data; compare the respective deviations with a threshold value; and when at least one of the respective deviations exceeds the threshold value, determine the estimated configuration-parameter changes that are predicted to produce an acceptable tool-matching state for the plurality of measuring instruments at the future time.

In some examples of any of the above systems, the first controller is configured to determine the estimated configuration-parameter changes using a neural network trained with previous drift and calibration data corresponding to the plurality of measuring instruments.

In some examples of any of the above systems, when the plurality of reports indicates ineffectiveness of the estimated configuration-parameter changes for the tool matching of the plurality of measuring instruments at the future time, the first controller is configured to decide whether the plurality of measuring instruments is placeable into an acceptable tool-matching state at the future time without a maintenance service or fleetwide calibration.

In some examples of any of the above systems, when a determination is made that the plurality of measuring instruments is not placeable into the acceptable tool-matching state without the maintenance service or fleetwide calibration, the first controller is configured to flag the plurality of measuring instruments for the maintenance service or for the fleetwide calibration.

In some examples of any of the above systems, when a determination is made that the plurality of measuring instruments is placeable into the acceptable tool-matching state without the maintenance service or fleetwide calibration, the first controller is configured to generate a modified set of configuration-parameter changes based on the plurality of reports.

In some examples of any of the above systems, each of the measuring instruments is an electron microscope instrument or a focused ion beam instrument.

In some examples of any of the above systems, the respective digital twin includes a plurality of model modules representing different respective physical components of the electron microscope instrument or the focused ion beam instrument, the model modules being subjected to recurrent parameter updates based on comparison of measurement results and corresponding model simulations.

In some examples of any of the above systems, the plurality of measuring instruments includes five or more measuring instruments.

In some examples of any of the above systems, a second controller of the plurality of second controllers is configured to: evaluate the respective subset of the estimated configuration-parameter changes by inputting said respective subset into the respective digital twin and running simulations to compute corresponding deviations; and generate a respective one of the plurality of reports for the first controller based on the computed deviations.

In some examples of any of the above systems, the second controller is further configured to execute an action in response to an instruction received from the first controller, the action being selected from the group consisting of: sending additional instrument drift data to the first controller; performing a next iteration of evaluating the estimated configuration-parameter changes with the respective digital twin; implementing a respective subset of the estimated configuration-parameter changes with the corresponding one of the plurality of measuring instruments; and configuring the corresponding one of the plurality of measuring instruments for a maintenance service or fleetwide calibration.

It is to be understood that the above description is intended to be illustrative and not restrictive. Many implementations and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed subject matter incorporate more features than are expressly recited in each claim. Rather, as the following claims reflect, inventive subject matter lies in fewer than all features of a single disclosed example. Thus, the following claims are hereby incorporated into the Detailed Description, with each claim standing on its own as a separately claimed subject matter.

Unless explicitly stated otherwise, each numerical value and range should be interpreted as being approximate as if the word “about” or “approximately” preceded the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An automated tool-matching method for a plurality of measuring instruments, the method comprising:
with a first controller, estimating configuration-parameter changes for the plurality of measuring instruments based on instrument drift data received from a plurality of second controllers, the estimated parameter changes being directed at tool matching the plurality of measuring instruments at a future time, each of the second controllers being configured to support a respective digital twin of a corresponding one of the measuring instruments and further configured to control configuration parameters of the corresponding one of the measuring instruments;
with the first controller, receiving from the plurality of second controllers a plurality of reports evaluating the estimated configuration-parameter changes, each of the reports being generated with the respective digital twin based on a respective subset of the estimated configuration-parameter changes for the plurality of measuring instruments; and
with the first controller, instructing the plurality of second controllers to implement the estimated configuration-parameter changes when the plurality of reports indicates effectiveness of the estimated configuration-parameter changes for the tool matching of the plurality of measuring instruments at the future time.

2. The method of claim 1, wherein the estimating comprises:
predicting respective deviations for the plurality of measuring instruments at the future time based on the instrument drift data;
comparing the respective deviations with a threshold value; and
when at least one of the respective deviations exceeds the threshold value, determining the estimated configuration-parameter changes that are predicted to produce an acceptable tool-matching state for the plurality of measuring instruments at the future time.

3. The method of claim 2, wherein the determining is performed using a neural network trained with previous drift and calibration data corresponding to the plurality of measuring instruments.

4. The method of claim 1, further comprising:
when the plurality of reports indicates ineffectiveness of the estimated configuration-parameter changes for the tool matching of the plurality of measuring instruments at the future time, deciding, with the first controller, whether the plurality of measuring instruments is placeable into an acceptable tool-matching state at the future time without a maintenance service or fleetwide calibration.

5. The method of claim 4, further comprising:
when the deciding produces a determination that the plurality of measuring instruments is not placeable into the acceptable tool-matching state without the maintenance service or fleetwide calibration, flagging the plurality of measuring instruments for the maintenance service or for the fleetwide calibration.

6. The method of claim 4, further comprising:
when the deciding produces a determination that the plurality of measuring instruments is placeable into the acceptable tool-matching state without the maintenance service or fleetwide calibration, performing a next iteration of the estimating further based on the plurality of reports.

7. The method of claim 1, wherein each of the measuring instruments is an electron microscope instrument or a focused ion beam instrument.

8. The method of claim 7, wherein the respective digital twin includes a plurality of model modules representing different respective physical components of the electron microscope instrument or the focused ion beam instrument, the model modules being subjected to recurrent parameter updates based on comparison of measurement results and corresponding model simulations.

9. The method of claim 1, wherein the plurality of measuring instruments includes five or more measuring instruments.

10. A tool-matching system, comprising:
a first controller; and
a plurality of second controllers, each of the second controllers being configured to support a respective digital twin of a corresponding one of a plurality of measuring instruments and further configured to control configuration parameters of the corresponding one of the measuring instruments,
wherein the first controller is configured to:
estimate configuration-parameter changes for the plurality of measuring instruments based on instrument drift data received from the plurality of second controllers, the estimated parameter changes being directed at tool matching the plurality of measuring instruments at a future time;
receive from the plurality of second controllers a plurality of reports evaluating the estimated configuration-parameter changes, each of the reports having been generated with the respective digital twin based on a respective subset of the estimated configuration-parameter changes for the plurality of measuring instruments; and
instruct the plurality of second controllers to implement the estimated configuration-parameter changes when the plurality of reports indicates effectiveness of the estimated configuration-parameter changes for the tool matching of the plurality of measuring instruments at the future time.

11. The system of claim 10, wherein, to estimate the configuration-parameter changes, the first controller is configured to:
predict respective deviations for the plurality of measuring instruments at the future time based on the instrument drift data;
compare the respective deviations with a threshold value; and
when at least one of the respective deviations exceeds the threshold value, determine the estimated configuration-parameter changes that are predicted to produce an acceptable tool-matching state for the plurality of measuring instruments at the future time.

12. The system of claim 11, wherein the first controller is configured to determine the estimated configuration-parameter changes using a neural network trained with previous drift and calibration data corresponding to the plurality of measuring instruments.

13. The system of claim 10, wherein, when the plurality of reports indicates ineffectiveness of the estimated configuration-parameter changes for the tool matching of the plurality of measuring instruments at the future time, the first controller is configured to decide whether the plurality of measuring instruments is placeable into an acceptable tool-matching state at the future time without a maintenance service or fleetwide calibration.

14. The system of claim 13, wherein, when a determination is made that the plurality of measuring instruments is not placeable into the acceptable tool-matching state without the maintenance service or fleetwide calibration, the first controller is configured to flag the plurality of measuring instruments for the maintenance service or for the fleetwide calibration.

15. The system of claim 13, wherein, when a determination is made that the plurality of measuring instruments is placeable into the acceptable tool-matching state without the maintenance service or fleetwide calibration, the first controller is configured to generate a modified set of configuration-parameter changes based on the plurality of reports.

16. The system of claim 10, wherein each of the measuring instruments is an electron microscope instrument or a focused ion beam instrument.

17. The system of claim 16, wherein the respective digital twin includes a plurality of model modules representing different respective physical components of the electron microscope instrument or the focused ion beam instrument, the model modules being subjected to recurrent parameter updates based on comparison of measurement results and corresponding model simulations.

18. The system of claim 10, wherein the plurality of measuring instruments includes five or more measuring instruments.

19. The system of claim 10, wherein a second controller of the plurality of second controllers is configured to:
evaluate the respective subset of the estimated configuration-parameter changes by inputting said respective subset into the respective digital twin and running simulations to compute corresponding deviations; and
generate a respective one of the plurality of reports for the first controller based on the computed deviations.

20. The system of claim 19, wherein the second controller is further configured to execute an action in response to an instruction received from the first controller, the action being selected from the group consisting of:
sending additional instrument drift data to the first controller;
performing a next iteration of evaluating the estimated configuration-parameter changes with the respective digital twin;
implementing a respective subset of the estimated configuration-parameter changes with the corresponding one of the plurality of measuring instruments; and
configuring the corresponding one of the plurality of measuring instruments for a maintenance service or fleetwide calibration.
